(19) United States
(12) Patent Application Publication
(10) Pub. No.: US 2006/0210158 A1
(43) Pub. Date: Sep. 21, 2006

(54) Object-specific segmentation

(75) Inventors: Vladimir Pekar, Hamburg (DE); Michael Reinhold Kaus, Hamburg (DE); Todd McNutt, Verona (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N. V., Eindhoven (NL)

(21) Appl. No.: 10/564,657

(22) PCT Filed: Jul. 13, 2004
(86) PCT No.: PCT/IB04/51208

§ 371 Date: Jan. 13, 2006

(30) Foreign Application Priority Data
Jul. 16, 2003 (EP) 03102191.8

(51) Int. Cl. G06K 9/34; G06K 9/00

(52) U.S. Cl. 382/173; 382/128; 382/154

(57) ABSTRACT

The invention relates to the field of efficient segmentation of collections of anatomical structures in medical imaging. For example, in radiotherapy planning, the segmentation of a collection of several anatomical structures, which represent the target volume in risk organs is required. When using model based segmentation, organ models represented by flexible surfaces are adapted to the boundaries of the object of interest. According to an aspect of the present invention, object-specific a priori information is incorporated in the segmentation process, which allows to provide for an improved segmentation. Furthermore, the segmentation process according to the present invention, may have an improved robustness, also the time required for the segmentation maybe reduced.

The present invention relates to the field of digital imaging. In particular, the present invention relates to a method of segmenting an object of interest from a multi-dimensional dataset, to an image processing device and to a computer program for segmenting an object of interest from a multi-dimensional dataset.

Segmentation methods are used to derive geometric models of, for example, organs or bones or other objects of interest from multi-dimensional datasets, such as volumetric image data, such as CT, MR or US images. Such geometric models are required for a variety of medical applications, or generally in the field of pattern recognition. For medical or clinical applications, an important example is cardiac diagnosis, where geometric models of the ventricles and the myocardium of the heart are required, for example, for perfusion analysis, wall motion analysis and computation of the ejection fraction. Another important clinical application is radio-therapy planning (RTP), where the segmentation of multiple organs and bones, for example, in the prostate region, is necessary for the diagnosis and/or the determination of the treatment parameters.

Deformable models are a very general class of methods for the segmentation of structures in 3D images. Deformable models are known, for example, from an article of T. McInerney et al. “Deformable models in medical image analysis: A survey” in Medical Image Analysis, 1 (2): 91-108 1996.

Segmentation by deformable models is typically carried out by adapting flexible meshes, represented, for example, by triangles or simplexes, to the boundaries of the object of interest in an image. For this, the model is initially placed near or on the object of interest in the image. This may be done by a user. Then, coordinates of surface elements of the flexible mesh, such as triangles, are iteratively changed until they lie on or close to the surface of the object of interest. Such a method is described in further detail in J. Weese et al. “Shape constrained deformable models for 3D medical image segmentation” in 17^{th} International Conference on Information Processing in Medical Imaging (IPMI), pages 380 to 387, Davies, Calif., USA, 2001, Springer Verlag.

The optimal adaptation of an initial mesh is found by energy minimization, where maintaining the shape of a geometric model is traded off against detected feature points of the object surface in the image. Feature point detection may be carried out locally for each triangle or simplex by searching for possible object surfaces in the image, for example, for the maximum image gradient along a normal of the triangle or simplex.

Such segmentation methods may, however, fail to correctly segment anatomical structures with complex and/or ambiguous feature information. One example is the segmentation of the rectum in radiation therapy planning (RTP), where air may be present, and the correct segmentation of the rectum wall is difficult.

It is an object of the present invention to provide for an improved object segmentation.

According to an exemplary embodiment of the present invention, the above object may be solved by a method of segmenting an object of interest from a multi-dimensional dataset, such as an image, wherein a deformable model surface is to be adapted to a surface of the object. According to an aspect of the present invention, object-specific data is acquired, which is used during the adaptation of the deformable surface model to the surface of the object. Advantageously, due to the use of object-specific a priori information adaptation of the segmentation process for adapting the deformable surface model to the surface of the object, an improved segmentation may be provided, where, for example, a rectum wall, even in the presence of air in the rectum, may be segmented. Furthermore, advantageously, the method according to this exemplary embodiment of the present invention may provide for an improved segmentation of different objects which are located close to each other. Advantageously, a differentiation between those close objects may be improved.

According to another exemplary embodiment of the present invention as set forth in claim 2, the object-specific data is selected from the group consisting of shape properties in the form of a polygonal model representing the object surface, a point distribution shape model, for example, as described in Cootes et al. “The use of active shape models for locating structures in medical images” in Image and Vision Computing, 12(6): pages 355-366, 1994, which is hereby incorporated by reference, an object-specific feature search function, an object-specific parameter setting and object-specific material properties. Advantageously, according to this exemplary embodiment of the present invention, a robustness of a model based segmentation of collections of anatomical structures such as, for example, in radiotherapy planning (RTP) may be increased.

According to another exemplary embodiment of the present invention as set forth in claim 3, an object-specific feature search function is applied, which is adapted such that it responds to a pre-defined range of values selected from a group consisting of a gradient, a gradient direction and an intensity range. Advantageously, returning to the example of the air filled rectum, this allows, for example, to apply a different threshold value in the case that an air bubble is detected in the rectum, which inherently causes a very steep gradient.

According to another exemplary embodiment of the present invention as set forth in claim 4, the object-specific parameter setting is adapted to control the influence of image features and shape constraints.

For example, when segmenting bony structures such as femoral heads or spinal vertebrae, the organ variability is limited, and the value of the weighting parameter for the internal energy controlling the shape deviation from the model can be larger compared to that parameter for the soft tissue organs, e.g. bladder.

According to another exemplary embodiment of the present invention as set forth in claim 5, the object-specific material properties relate to tissue properties of an organ. Such tissue properties may, for example, be an elasticity of the tissue or a blood supply in an organ region. Such tissue properties may, for example, be assigned to the internal nodes of the volumetric mesh of the deformable surface model.

According to another exemplary embodiment of the present invention as set forth in claim 6, the organ specific data is acquired by displaying a graphical user interface (GUI) to a user and prompting the user to input such information. Then, this input is read and written into a memory. Advantageously, this may allow for an interactive input of such information during operation and, furthermore, for a later re-use of such information in a “drag and drop” style during later operation.

According to another exemplary embodiment of the present invention as set forth in claim 7, the object-specific data is read from a memory. According to this, organ specific data may be collected in a memory and stored for later re-use.

According to another exemplary embodiment of the present invention as set forth in claim 8, the method according to the present invention is an organ segmentation method for segmenting anatomical structures in medical images. According to another exemplary embodiment of the present invention as set forth in claim 9, an image processing device is provided, comprising a memory for storing acquired object-specific data and an image processor for segmenting an object of interest from an image. In this image processor, a deformable surface model is adapted to a surface of the object by using the object-specific data. Advantageously, due to the incorporation of object-specific a prior information to the segmentation process, the robustness of the model based segmentation of, for example, anatomical structures, may be improved. Furthermore, the segmentation results have an improved reliability, due to the incorporation of the object-specific a priori information in the segmentation process or in organ deformation prediction.

According to another exemplary embodiment of the present invention as set forth in claim 10, a computer program is provided, allowing for an improved segmentation. The computer program may be written in any suitable program language, such as C++ and may be stored on a computer readable device, such as a CD-ROM. However, the computer program according to the present invention may also be presented over a network such as the WorldWideWeb, from which it may be downloaded.

It may be seen as the gist of an exemplary embodiment of the present invention that object-specific a priori information is incorporated into the segmentation process. According to an aspect of the present invention, it may also be incorporated into organ deformation prediction. In particular, this may be done interactively by prompting the user to input such information by displaying a GUI to the user. The input information may then be stored in a memory for later retrieval. Advantageously, this may allow for an activation of such information in a drag and drop style.

These and other aspects of the present invention will become apparent from an elucidated with reference to the embodiments described hereinafter.

Exemplary embodiments of the present invention will be described in the following with reference to the following drawings:

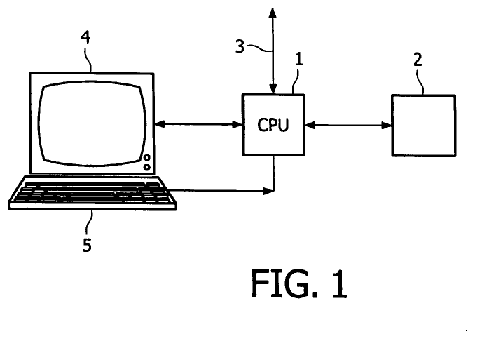

FIG. 1 shows a schematic representation of an image processing device according to an exemplary embodiment of the present invention, adapted to execute a method according to an exemplary embodiment of the present invention.

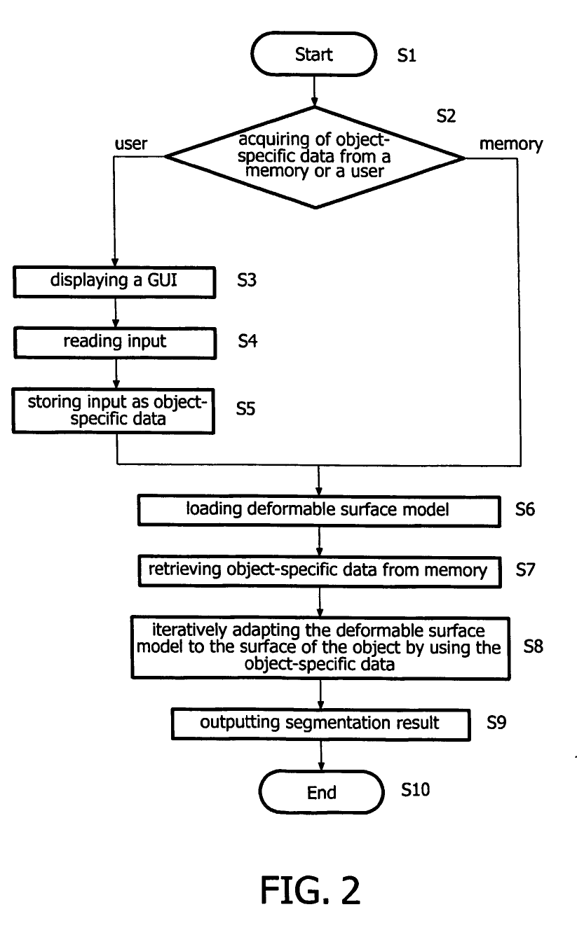

FIG. 2 shows a simplified flowchart of an exemplary embodiment of a method for operating the image processing device of FIG. 1 according to the present invention.

FIG. 1 shows a simplified schematic representation of an exemplary embodiment of an image processing device in accordance with the present invention. In FIG. 1 there is shown a central processing unit (CPU) or image processor 1 for adapting a deformable model surface to surfaces of an object of interest by mesh adaptation. The object may also be composed of multiple objects. In addition to being conceived to adapt a deformable model surface to the object surface, the image processing device depicted in FIG. 1 may also be adapted to determine or generate a surface model from one or a plurality of training models.

The image processor 1 is connected to a memory 1 for storing a multi-dimensional dataset. Such multi-dimensional datasets are referred to the in the following as images. The image processor 1 may be connected by a bus system 3 to a plurality of periphery devices or input/output devices which are not depicted in FIG. 1. For example, the image processor 1 may be connected to an MR device, a CT device, an ultrasonic scanner, to a plotter or a printer or the like via the bus system 3. Furthermore, the image processor 1 is connected to a display such as a computer screen 4 for outputting segmentation results. Furthermore, the display may be used to display a graphical user interface (GUI) to prompt the user to input object-specific a priori information. Furthermore, a keyboard 5 is provided, connected to the image processor 1, by which a user or operator may interact with the image processor 1 or may input data necessary or desired for the segmentation process.

FIG. 2 shows a simplified flowchart of an exemplary embodiment of a method for operating the image processing device depicted in FIG. 1.

After the start in step S1, the method continues to step S2, where it is determined whether the object-specific data is acquired from a memory or a user. In case it is determined in step S2 that the object-specific data is acquired from a user, the method continues to step S3. In step S3, a GUI is generated by the image processor 3 and output to a user via the display. The GUI may prompt the user to input object-specific data. For this, the GUI may be adapted as a template, comprising blanks, where the user may input the specific information. The specific information is a combination of organ specific a priori knowledge, which is incorporated into the subsequent segmentation process. According to an exemplary embodiment of the present invention, anatomical structures are segmented in medical images. In such cases, the organ specific a priori knowledge may relate to shape properties, for example, in the form of an organ specific shape model which is applied. Such organ specific shape model may, for example, be a point distribution model (PDM) as described in Cootes et al. “The use of active shape models for locating structures in medical images” in Image and Vision Computing, 12(6): pages 355-366, 1994, which is hereby incorporated by reference, consisting of the mean organ shape as well as principal variation modes.

Furthermore, according to an aspect of the present invention, such organ specific a priori knowledge may relate to organ specific feature search functions, which are applied to detect feature points on the object surface in the image. Suitable feature search functions are, for example, described in detail in J. Weese et al. “Shape constrained deformable models for 3D image segmentation” in 17^{th} International Conference on Information Processing in Medical Imaging (IPMI), pages 380 to 387, Davies, Calif., USA, 2001, Springer Verlag, which is hereby incorporated by reference. Thus, in accordance with an aspect of the present invention, these organ specific feature search functions may be adapted such that they respond to a pre-defined range of values. Such values may, for example, be a gradient in the object region of the image, an intensity range or a gradient direction. Furthermore, the organ specific a priori knowledge may relate to organ specific parameter settings to control the influence of image features and shape constraints.

For example, when segmenting bony structures such as femoral heads or spinal vertebrae, the organ variability is limited, and the value of the weighting parameter for the internal energy controlling the shape deviation from the model can be larger compared to that parameter for the soft tissue organs, e.g. bladder.

Furthermore, material properties of the organ of interest may be taken into account. Such organ specific knowledge, as indicated above, may either be input by a user or read from a memory. Such material properties may relate to, for example, an elasticity of the respective organ tissue. Such tissue properties may, for example, be assigned to the total amounts of a volumetric mesh.

All of the above listed organ specific a priori data may also be used for tasks other than organ segmentation, for example, for organ deformation prediction and 4D RTP.

After an operator or user has filled out the blanks in the GUI, the method continues to step S4, where the information input by the user or operator is read. Then, the method continues to step S5, where the object-specific data input and read in steps S3 and S4 is stored in a memory as object-specific data. Then, the method continues to step S6.

In case it was determined in step S2 that the object-specific data is read from a memory, the method continues to step S6. In step S6, the suitable deformable surface model corresponding to the organ to be segmented, is loaded. The deformable surface model may be specifically adapted to the organ to be segmented. For example, in case the prostate region is to be segmented, a corresponding prostate region deformable surface model is loaded. Then, the method continues to step S7, where the object-specific data is retrieved from the memory. Then, in the subsequent step S8, the deformable surface model is iteratively adapted to the surface of the object by using the object-specific data as described with reference to steps S3 and S4. The generation of a suitable deformable surface model and the adaptation of the surface model to the object of interest is described in further detail in J. Weese et al “Shape constrained deformable models for 3D image segmentation” in 17^{th} International Conference on Information Processing in Medical Imaging (IPMI), pages 380 to 387, Davies, Calif., USA, 2001, Springer Verlag, which is hereby incorporated by reference.

According to an aspect of this exemplary embodiment of the present invention, during the feature search, points which do not comply to a search profile with the properties of the respective organ (e.g. the gray values, the value and direction of the gradient etc.) are ignored and not taken into account. E.g., for the bladder, the interval of the gray values differs from the interval of the femur which may be used according to an aspect of the present invention.

Then, the method continues to step S9, where the segmentation result is output. After the output of the segmentation result in step S9, the method continues to step S10, where it ends.

Advantageously, the above described method allows to further increase the robustness of the model based segmentation of collections of anatomical structures. In particular, it allows for an improved radiotherapy planning, where a segmentation of a collection of several anatomical structures, which represent a target volume an risk organs is required. As set forth above, this may in particular be achieved by incorporating a priori object of organ specific information into the segmentation process.

Furthermore, due to the fact that the organ specific data may be interactively input by a user and subsequently stored in a memory, either an interactive process may be provided, or a semi-automatic process, where the respective organ specific information may be presented to a user, such that the user may activate such pre-stored information in a drag and drop style.

In particular, such organ specific information may be presented to the user in a way that pre-stored organ specific data is automatically displayed to the user, which the user may accept or alter accordingly.

Apart from providing a very robust model based segmentation with an improved accuracy, the above method may allow to considerably reduce the time required for treatment planning, in particular in RTP.

1. Method of segmenting an object of interest from a multi-dimensional dataset, wherein a deformable surface model is to be adapted to a surface of the object, method comprising the steps of: acquiring object-specific data; adapting the deformable surface model to the surface of the object by using the object-specific data.

2. The method of claim 1, wherein the object-specific data is selected from the group consisting of shape properties in the from of an object model, a point distribution model, an object-specific feature search function, an object-specific parameter setting and object-specific material properties.

3. The method of claim 2, wherein the object-specific feature search function is adapted to a predefined range of values selected from the group consisting of a gradient, a direction of a gradient and an intensity range.

4. The method of claim 2, wherein the object-specific parameter setting is adapted to control an influence of image features and shape constraints.

5. The method of claim 2, wherein the object-specific material properties relate to tissue properties of an organ which are assigned to internal nodes of a volumetric mesh of the deformable surface model.

6. The method of claim 1, wherein the step of acquiring object-specific data comprises the steps of: displaying a graphical user interface on a display prompting a user to input object related information; receiving a corresponding data input from an input device; storing the data input as object-specific data in a memory.

7. The method of claim 1, wherein the step of acquiring object-specific data comprises the steps of: reading the object-specific data from a memory.

8. The method of claim 1, wherein the method is an organ segmentation method for segmenting anatomical structures in medical images.

9. Image processing device, comprising: a memory for storing acquired object-specific data; and an image processor for segmenting an object of interest from an image, wherein a deformable surface model is adapted to a surface of the object by using the object-specific data.

10. Computer program for segmenting an object of interest from a multi-dimensional dataset, wherein a deformable surface model is to be adapted to a surface of the object, wherein the computer program causes a processor to perform the following steps when the computer is executed on the processor: acquiring object-specific data; adapting the deformable surface model to the surface of the object by using the object-specific data.
